(19) United States
(12) Patent Application Publication
(10) Pub. No.: US 2012/0309225 A1
(43) Pub. Date: Dec. 6, 2012

(54) ELECTRICAL CONNECTOR HAVING CRIMP-MOUNTED ELECTRICAL TERMINALS

(76) Inventors: Motomu Kajiura, Tokyo (JP); Yasutoshi Kameda, Kisarazu-shi (JP); Jeffery Garvais, Beaverton, OR (US)

(21) Appl. No.: 13/486,290

(22) Filed: Jun. 1, 2012

Related U.S. Application Data
(60) Provisional application No. 61/492,350, filed on Jun. 1, 2011.
(60) Provisional application No. 61/492,339, filed on Jun. 1, 2011.

(51) Int. Cl. H01R 4/24

(52) U.S. Cl. 439/422

(57) ABSTRACT

In accordance with one embodiment, an electrical connector includes a connector housing, and at least one electrical terminal supported by the connector housing. The electrical terminal defines a mating portion and a mounting portion, the mounting portion carrying a pair of crimp members having crimp teeth configured to pierce through a flex cable when crimped so as to mount the flex cable to the mounting portion of the electrical terminal.

### CROSS-REFERENCE TO RELATED APPLICATIONS

This claims the benefit of U.S. provisional patent application Ser. No. 61/492,350 filed Jun. 1, 2011, the disclosure of which is hereby incorporated by reference as if set forth in its entirety herein.

The present application is related by subject matter to U.S. provisional patent application Ser. No. 61/492,339 filed Jun. 1, 2011, and is further related by subject matter to U.S. design patent Ser. Nos. 29/393,270 filed Jun. 1, 2011, 29/393,276 filed Jun. 1, 2011, 29/393,282 filed Jun. 1, 2011, 29/393,269 fled Jun. 1, 2011, 29/393,278 filed Jun. 1, 2011, 29/393,281 filed Jun. 1, 2011, and 29/393,283 filed Jun. 1, 2011.

### TECHNICAL FIELD

The present disclosure relates to electrical connectors, and in particular relates to an electrical terminal including a crimp fitting.

### BACKGROUND

Electrical connectors conventionally include a housing that retains a plurality of electrically conductive terminals that define opposed mounting ends and mating ends configured to be placed in electrical communication with respective first and second complementary electrical devices. For instance, flat flex cables are widely used to connect the first electrical device to the mounting end of an electrical connector. Accordingly, when the electrical connector is mated to the second electrical device, the first and second electrical devices are placed in electrical communication. Flat flex cables have found increasing use as a replacement for costly and, in particular, heavy-weight cable harnesses.

### SUMMARY

In accordance with one embodiment, an electrical connector includes a connector housing and at least one electrical terminal supported by the housing. The electrical terminal can define a mating portion and a mounting portion, the mounting portion carrying at least one crimp member that has crimp teeth configured to pierce through a flex cable when crimped so as to mount the flex cable to the mounting portion of the electrical terminal. The electrical terminal further includes a spring section that extends between the mating end and the mounting end, the spring section configured to compress such that the mating end moves toward the mounting end.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1A is a perspective view of an electrical connector assembly constructed in accordance with one embodiment, including an electrical connector and a flat flex cable configured to be electrically connected to the electrical connector;

FIG. 1B is a perspective view of the electrical connector illustrated in FIG. 1A, including a connector housing and a plurality of electrical terminals supported by the connector housing, shown in an unlocked configuration;

FIG. 1C is a perspective view of the electrical connector illustrated in FIG. 1A, shown in a locked configuration;

FIG. 2A is a top plan view of the electrical connector illustrated in FIG. 1A, showing a portion removed;

FIG. 2B is a perspective view of a portion of the electrical connector illustrated in FIG. 2A, taken at region 2A, and shown with a latch lever removed;

FIG. 2C is an enlarged region of the portion of the electrical connector illustrated in FIG. 2B, taken at region 2C;

FIG. 3A is a perspective view of one of the electrical terminals of the electrical connector illustrated in FIG. 1A;

FIG. 3B is another perspective view of the electrical terminal illustrated in FIG. 3A;

FIG. 3C is a side elevation view of the electrical terminal illustrated in FIG. 3A;

FIG. 3D is a top plan view of the electrical terminal illustrated in FIG. 3A;

FIG. 4A is a perspective view of another one of the electrical terminals of the electrical connector illustrated in FIG. 1A;

FIG. 4B is another perspective view of the electrical terminal illustrated in FIG. 4A;

FIG. 4C is a side elevation view of the electrical terminal illustrated in FIG. 4A;

FIG. 4D is a top plan view of the electrical terminal illustrated in FIG. 4A;

FIG. 5A is a perspective view of an electrical terminal similar to the electrical terminal illustrated in FIG. 3A, but constructed in accordance with an alternative embodiment;

FIG. 5B is another perspective view of the electrical terminal illustrated in FIG. 5A;

FIG. 5C is a side elevation view of the electrical terminal illustrated in FIG. 5A;

FIG. 5D is a top plan view of the electrical terminal illustrated in FIG. 5A;

FIG. 6A is a perspective view of an electrical terminal similar to the electrical terminal illustrated in FIG. 4A, but constructed in accordance with an alternative embodiment;

FIG. 6B is another perspective view of the electrical terminal illustrated in FIG. 6A;

FIG. 6C is a side elevation view of the electrical terminal illustrated in FIG. 6A;

FIG. 6D is a top plan view of the electrical terminal illustrated in FIG. 6A;

FIG. 7 is a diagrammatic view of a portion of a vehicle having a safety restraint system that includes the electrical connector assembly illustrated in FIG. 1;

FIG. 8 is a top plan view of a seat sensor device used in the vehicle safety restraint system shown in FIG. 7;

FIG. 9 is a bottom plan view of a portion of the seat sensor device shown in FIG. 8;

FIG. 10 is an enlarged perspective view of a portion of the seat sensor device shown in FIG. 8, but without showing the flexible printed circuit may merely for the sake of clarity;

FIG. 11 is a partial top plan view of a portion of the flexible printed circuit mat, the frame, and three terminals prior to connection of a Hall effect sensor assembly; \

FIG. 12 is a perspective view of a first housing member of the sensor assembly shown in FIG. 10;

FIG. 13 is a cross sectional view of a first subassembly of the sensor assembly shown in FIG. 10 comprising the first housing member shown in FIG. 12 and a Hall effect sensor;

FIG. 14 is a perspective view of the first subassembly shown in FIG. 13 with a cutaway section;

FIG. 15 is a perspective view of a second housing member used in the sensor assembly shown in FIG. 10;

FIG. 16 is a cross sectional view of a second subassembly used in the sensor assembly shown in FIG. 10 comprising the second housing member shown in FIG. 15 and a permanent magnet;

FIG. 17 is a perspective view as in FIG. 10 with the second subassembly moved towards a depressed position;

FIG. 18 is a top plan view of one of the terminals used to connect the sensor assembly shown in FIG. 10 to the flexible printed circuit mat;

FIG. 19 is a side elevation view of the terminal shown in FIG. 18; and

FIG. 20 is a cross sectional view of the terminal shown in FIG. 19 taken along line 20-20.

### DETAILED DESCRIPTION

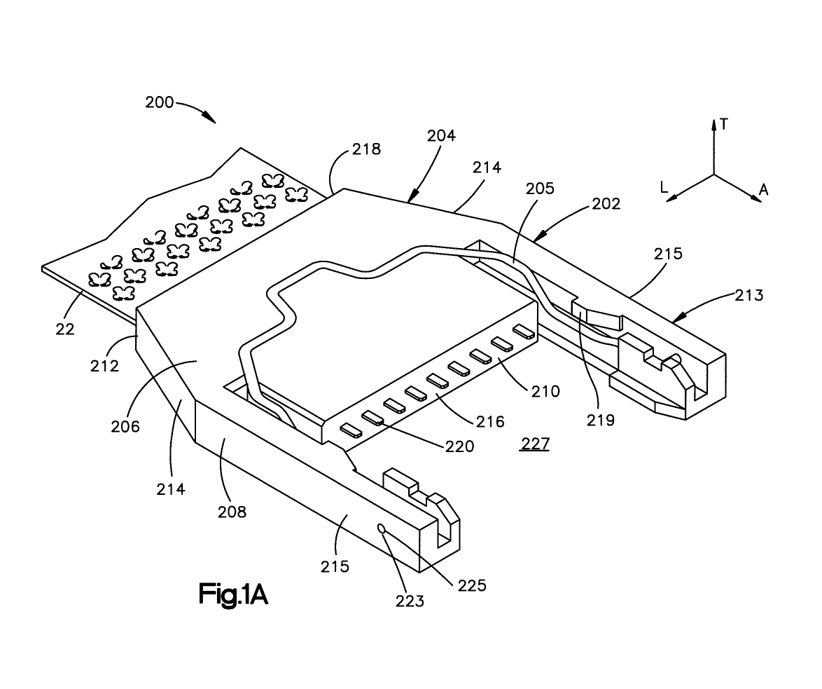

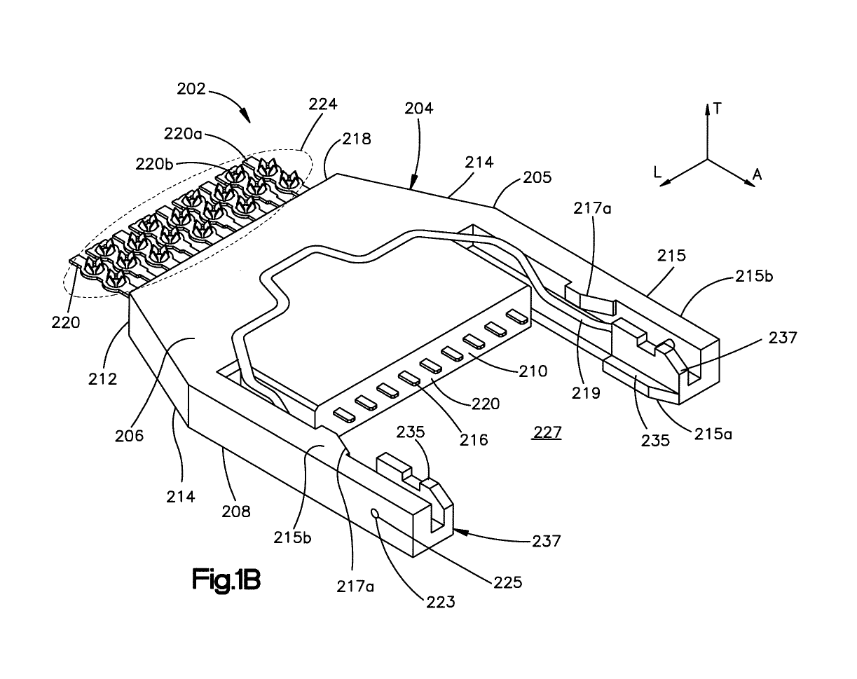

Referring to FIG. 1A, an electrical connector assembly 200 includes an electrical connector 202 that, in turn, includes a connector housing 204 that is dielectric or electrically insulative, and at least one such as a plurality of electrical terminals 220 that are supported by the connector housing 204. The electrical connector assembly 200 further includes a flat flex cable 22, also referred to as a flexible printed circuit (FPC), that is configured to be mounted onto the electrical connector 202 so as to establish an electrical connection with the electrical terminals. The connector housing 204 includes a housing body 205 that defines a top end 206, an opposed bottom end 208, a front end 210, an opposed rear end 212, and opposed sides 214. It should be appreciated that the terms “forward” and “rearward” and derivatives thereof refer to a direction from the rear end 212 toward the front end 210, and a direction from the front end 210 toward the rear end 212, respectively. The connector housing 204 defines first and second opposed ends that are configured to mate with a complementary connector and secure to the flat flex cable 22, respectively. For instance, the first end can be defined by the front end 210 and the second end can be defined by the rear end 212, the top end 206, or the bottom end 208, as described in more detail below. Thus, the connector housing 204 defines a mating interface 216 that can be disposed proximate to the front end 210, and a mounting interface 218 disposed proximate to the rear end 212, the top end 206, or the bottom end 208. The mounting interface 218 is configured to operatively engage the flat flex cable 22, while the mating interface 216 is configured to operatively engage a second complementary electrical connector so as to place the flat flex cable 22 in electrical communication with the second complementary electrical connector.

The opposed sides 214 are spaced apart along a first or longitudinal direction L, the front end rear ends 210 and 212 are spaced apart along a second or lateral direction A that is substantially perpendicular with respect to the longitudinal direction L, and the top and bottom ends 206 and 208 are spaced apart along a third or transverse direction T that is substantially perpendicular with respect to the lateral direction A and the longitudinal direction L. In accordance with the illustrated embodiment, the transverse direction T is oriented vertically, and the longitudinal and lateral directions L and A are oriented horizontally, though it should be appreciated that the orientation of the electrical connector 202 may vary during use. At least a portion of one or both of the sides 214 can be beveled inwardly toward the other of the sides 214 along a rearward direction from the front end 210 toward the rear end 212.

Referring now to FIGS. 1A-D, the connector housing 204 can include a latch assembly 213 that is configured to secure the electrical connector 202 to the complementary electrical connector. In accordance with one embodiment, the latch assembly 213 can be configured to releasably secure the electrical connector 202 to the complementary electrical connector when the electrical connector 202 is mated with the complementary electrical connector so as to place the electrical terminals 220 in electrical communication with respective electrical terminals of the complementary electrical connector. The latch assembly 213 can include at least one latch arm 215, such as a pair of longitudinally spaced latch arms 215, that each extends forward from the front end 210 of the housing body 205. The latch arms 215 can be spaced from each other along the longitudinal direction L. In accordance with one embodiment, each of the latch arms 215 can be inline with the sides 214 of the housing body 205, for instance at the front end of the housing body 205.

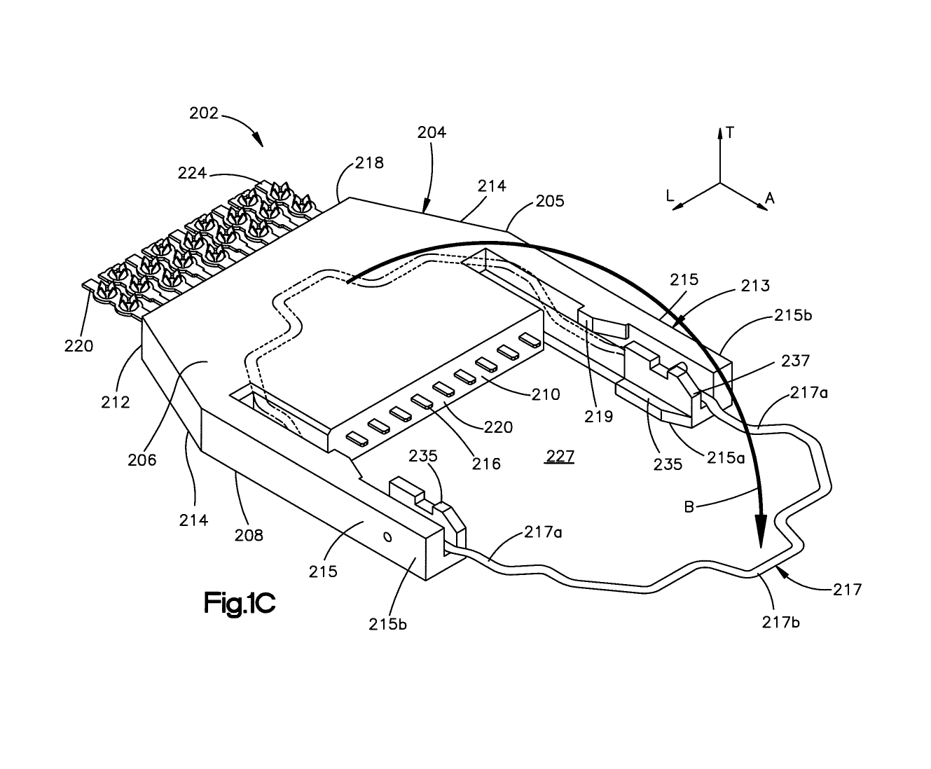

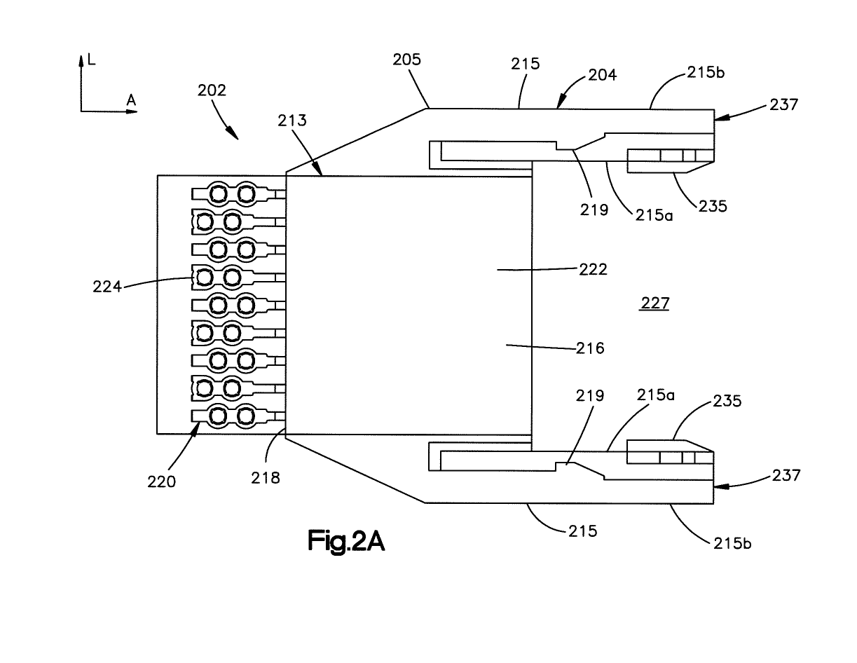

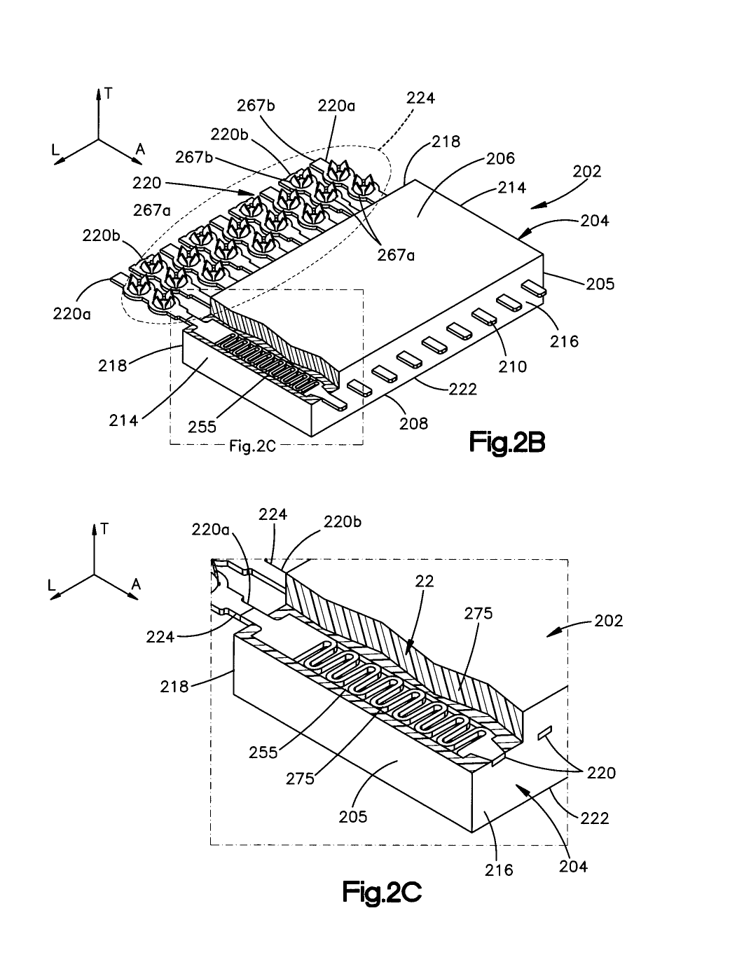

The latch assembly 213 can further include a latch lever 217 that is movable along the direction of Arrow A between a retracted position illustrated in FIG. 2B to an extended, or latched, position as illustrated in FIG. 2C. The latch lever 217 can be configured as a wire or other elongate member having opposed terminal ends 223, first proximal portions 217a that extend substantially along the lateral direction A from the terminal ends 223, and a second or intermediate portion 217b that extends between the proximal portions 217a substantially along the longitudinal direction L. Thus, each of the proximal portions 271a extends between a respective one of the terminal ends 223 and the intermediate portion 217b. It should be appreciated that the proximal portions 217a and the intermediate portion 217b can be straight, curved, or otherwise geometrically shaped as desired.

The terminal ends 223 are hingedly attached to the connector housing 204, for instance at the opposed latch arms 215. In accordance with the illustrated embodiment, the terminal ends 223 are hingedly attached to a front end of the latch arms 215. In accordance with the illustrated embodiment, each of the latch arms 215 can include a first or lower portion 215a and a second or upper portion 215b that extends up from the lower portion 215a along the transverse direction T. The lower portion 215a can be substantially inline or coplanar with the bottom end 208 of the housing body 205, and the upper portion 215b can be substantially inline or coplanar with the top end 206. The lower portion 215a of each of the latch arms 215 can extend inwardly along the longitudinal direction L greater than the upper portion 215b, such that the lower portion 215a defines a dimension in the longitudinal direction L that is greater than that of the upper portion 215b.

The latch assembly 213 can define an aperture 225 that extends along the longitudinal direction L at least into or through each latch arm 215, for instance at the lower portion 215a. The apertures 225 can be substantially inline with each other along the longitudinal direction L. Each of the apertures 225 are sized to receive respective ones of the terminal ends 223 of the latch lever 217, such that the terminal ends 223 are rotatable in the apertures 225. Thus, the apertures can define respective pivot locations, such that the latch lever 217 pivots about pivot locations defined by the apertures 225. In accordance with the illustrated embodiment, the latch lever 217 is pivotally coupled to the upper portion 215b, though it should be appreciated that the latch lever 217 can be pivotally coupled to the connector housing 204 so as to pivot about a pivot axis that extends along the longitudinal direction and extends through both the apertures 225 and the terminal ends 223.

Thus, the latch lever 217 is movable, for instance pivotable, along the direction of Arrow B about the pivot axis between a retracted position illustrated in FIG. 2B to an extended, or latched, position as illustrated in FIG. 2C. When the latch lever 217 is in the extended position, the intermediate portion 217b is disposed more forward along the lateral direction A than when the latch lever 217 is in the retracted position. For instance, when the latch lever 217 is in the retracted position, the proximal portions 217a extend substantially rearward toward the rear end 212 of the connector housing 204 from the respective apertures 225, and the intermediate portion 217b can be aligned with the housing body 205 along the transverse direction. For instance, the intermediate portion 217b can be disposed adjacent, or rest against, the top end 206 of the housing body 205 when the latch lever 217 is in the retracted position. When the latch lever 217 is in the extended position, the proximal portions 217a extend substantially forward from the respective apertures 225 away from the rear end 212 of the connector housing 204, and the intermediate portion 217b can be spaced forward from the housing body 205 along the lateral direction A.

Thus, when the latch lever 217 is in the extended position, the connector housing 204 defines a void 227 that is enclosed and sized to retain a complementary connector that is mated to the electrical connector 202. The void 227 can be at least partially defined by the latch lever 217, the latch arms 215, and the front end 210 of the housing body 205. It should be appreciated that the void 227 defines a front end that is open when the latch lever 217 is in the retracted position, and closed by the latch lever 217 when the latch lever is in the extended position. When the latch lever 217 is in the latched position, the electrical connector 202 is configured to capture the complementary electrical device between the latch lever 217 and the front end 210 of the connector housing 204. Thus, the electrical connector 202 is configured to receive the complementary electrical connector through the open end of the void 227 when the latch lever 217 is retracted, and the latch lever 217 can be moved to the extended position so as to releasably secure the complementary connector in the void 227. The latch lever 217 can be again retracted so as to open the void 227 and allow for removal of the complementary connector from the electrical connector 202. Thus, the latch assembly 213 is configured to releasably secure the complementary connector to the electrical connector when the electrical connector 202 is mated to the complementary connector.

Each latch arm 215 can further define a guide member 229 that is configured to guide the latch lever 217 between the extended and the retracted positions. For instance, the guide member 229 can include a guide wall 235 that extends up from the lower portion 215a of at least one such as each of the latch arms 215, so as to define a guide pocket 237 disposed between the guide wall 235 and the upper portion 215b along the longitudinal direction L. The lower portion 215a can define a base of the pocket 237. During operation, the guide pocket 237 can receive at least a portion of the respective proximal portion 217a of the latch arm 217 as the latch arm 217 is moved from the extended position to the retracted position.

The latch assembly 213 can further include at least one grip member 219 that is configured to releasably secure the latch arm 217 in the retracted position. In accordance with the illustrated embodiment, the latch assembly 213 includes a pair of grip members 219 that extend inwardly from each of the latch arms 215 toward the other of the latch arms 215. For instance, the grip members 219 extend from the upper portion 215b of the respective latch arm 215 at a location spaced from the lower portion 215a along the transverse direction T so as to define a gap that is sized to receive the latch arm 217 and capture the latch arm 217 between the grip member 219 and the latch arm, for instance at the lower portion 215a. During operation, as the latch arm 217 is moved from the extended position to the retracted position, the proximal portion 217a of the latch arm 217 is received in the pocket 237, and resiliently deflects inwardly from a normal position toward the other proximal portion 217a along the longitudinal direction as it rides along the grip members 219. The proximal portion 217a returns to the normal position once it is aligned with the gap that is defined between the grip member 219 and the lower portion 215a, and travels into the gap where the proximal portion 217a is releasably secured. In particular, an applied force to the latch arm 217 can be sufficient to overcome the frictional engagement between the grip member 219 and the proximal portion 217a, and cause the proximal portions 217a to ride along the grip member and resiliently flex inwardly out of interference with the grip member 219.

Referring now to FIGS. 1A-2C, the electrical connector 202 includes a plurality of electrical terminals 220 that are electrically conductive and retained or otherwise supported by the connector housing 204. The electrical connector 202 can include any number of electrical terminals 220 as desired. The electrical terminals 220 each define a mating portion 222 that is configured to electrically connect, for instance removably electrically connect, to a complementary electrical terminal of the complementary electrical connector when the electrical connector 202 is mated with the complementary electrical connector, and an opposed mounting portion 224 that is configured to electrically connect to the flat flex cable 22. The mating portion 222 is disposed proximate to the mating interface 216, and the opposed mounting portion 224 is disposed proximate to the mounting interface 218. In accordance with the illustrated embodiment, the mounting interface 218 can be dispose proximate to the rear end 212, though it should be appreciated that the electrical terminals 220 can be bent as desired, such that the mounting portions 224 extend along one of the top and bottom ends 206 and 208. For instance, the mounting portions 224 can extend along the surface that is opposite the surface that is adjacent the latch arm 217 when the latch arm 217 is in the retracted position. Thus, in accordance with the illustrated embodiment, the mounting portions 224 can extend along the bottom end 208, such that the bottom end 208 can define the mounting interface 218. Thus, the mating portions 222 can extend substantially in the lateral direction A along the top end 206 and can extend out from the top end 206, and the mounting portions 224 of the electrical terminals 220 can extend substantially in the lateral direction A along the bottom end 208 when the electrical terminals 220 are fully installed on the connector housing 204. Alternatively, the mounting portions 224 can extend rearwardly out from the rear end 212 of the housing body 205 along the lateral direction A.

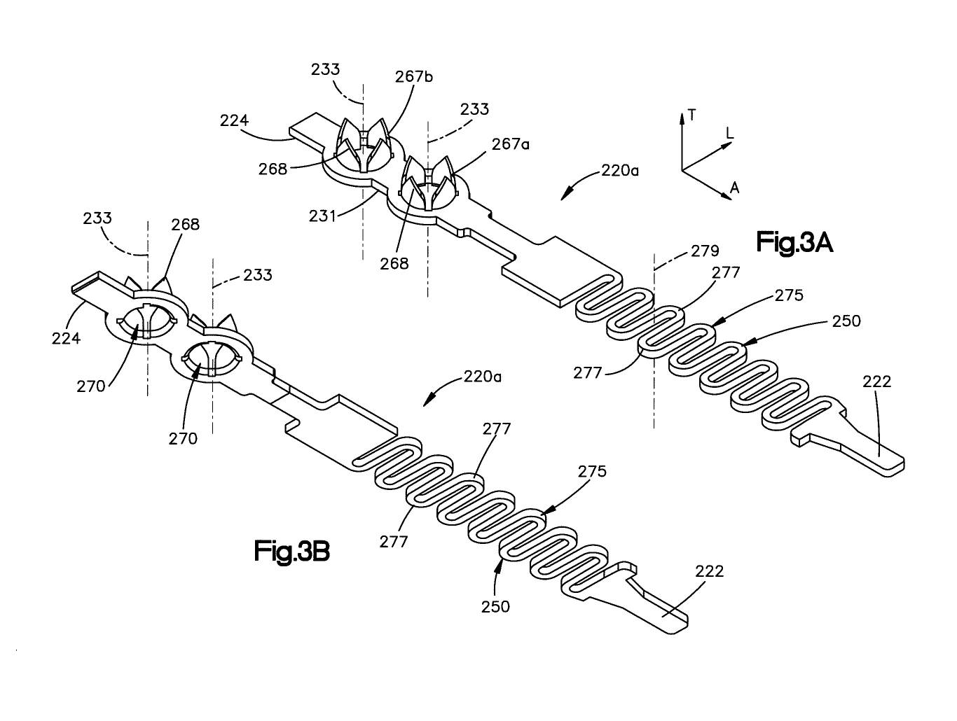

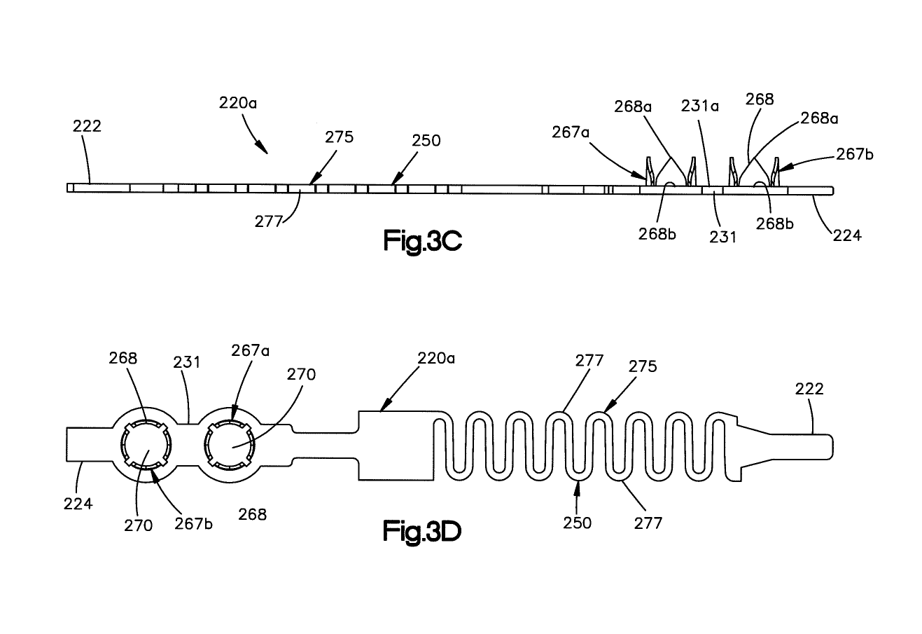

Referring also to FIGS. 3A-6D generally, each of the electrical terminals 220 can be configured as a battery terminal, and can include a terminal body that defines the mating portion 222 and the mounting portion 224, as well as an intermediate portion 250 that is connected between the mating portion 222 and the mounting portion 224. In accordance with the illustrated embodiment, the mating portion 222, the mounting portion 224, and the intermediate portion 250 are integral with each other. The intermediate portion 250 can extend through or along the housing body 205, such that the mating portion 222 extends from the front end 210 of the housing body 205 into the void 227 at a location between the latch arms 215. Thus, as the electrical connector 202 receives the complementary electrical connector in the void 227 so as to mate the electrical connector 202 with the complementary electrical connector, the mating portions 222 can make electrical contact with respective electrical terminals of the complementary electrical connector.

The mounting portion 224 can include a mounting member that can be configured as a substantially planar mounting plate 231 that can extends rearward along the lateral direction A with respect to the intermediate portion 250. The mounting plate 231 can have a thickness in the transverse direction T greater than a remainder of the electrical terminal 220, or can have a substantially constant thickness with respect to the remainder of the electrical terminal 220.

The mounting portion 224 of at least one up to all of the electrical terminals 220 can further includes at least one crimp member 267, such as a pair of crimp members 267a and 267b spaced from each other along the length of the electrical terminals, for instance along the lateral direction A, and carried by the mounting plate 231. In particular, each crimp member 267 includes a plurality of crimp teeth 268 that extend out, such as down when the terminals are bent so that the mounting plate 231 faces the bottom end 208 of the housing body 205, from the mounting portion 224, to a tapered distal end 268a in accordance with the illustrated embodiment. For instance, each of the crimp teeth 268 can define a base 268b that attaches to a surface 231a of the mounting plate 231 and a distal end 268a that is spaced from the base 268b along the transverse direction T. Thus, each crimp member 267 can extend from the mounting plate 231 along a direction that is substantially parallel to the direction in which the mating portion 222 is spaced from the mounting portion 224.

The electrical terminals 220 define respective mating portions 222 that face outwardly from a first housing surface (such as a surface defined by the front end 210 of the housing body 205) along a first direction, and the crimp teeth 268 face outwardly from a second housing surface (such as a surface defined by the bottom end 208 or the rear end 212 of the housing body 205) along a second direction that is different than the first direction. For instance, the second direction can be opposite the first direction, or can alternatively be substantially perpendicular to the first direction.

As illustrated, the crimp teeth 268 can be stamped or otherwise cut from the mounting plate 231 so as to define an aperture 270 that extends along central transverse axes 233 through the mounting plate 231 along the transverse direction T at each crimp member 267. Alternatively, the crimp teeth 268 can be discretely attached (e.g., welded) to the mounting plate 231. The crimp members 267 can include four crimp teeth 268 that are equidistantly spaced from each other about a perimeter of an aperture 270 that extends through the mounting plate 231 along the transverse direction T. The crimp teeth 268 of each crimp member 267 can be arranged about a circumference, for instance of the aperture 270, or other curved surface such that each crimp member 267 resembles the shape of a star having any number of lobes, each lobe defined by one of the crimp teeth 268 in accordance with the illustrated embodiment. It should be appreciated, however, that each crimp member 267 can include at least one crimp tooth, such as a plurality of crimp teeth 268 that are spaced equidistantly or variably from each other. The crimp teeth 268 of each crimp member 267 can be spaced circumferentially from each other or in any suitable alternative arrangement.

As illustrated in FIGS. 1A-B, the mounting portions 224 can be electrically connected to the flat flex cable 22 by crimping the crimp teeth 268 onto the flat flex cable 22, thereby placing the electrical terminals 220 in electrical communication with the electrical traces that run through the flat flex cable 22. For instance, mounting portion 224, and thus the mounting plate 231 can extend out from the connector housing 204 during a stamping operation, such that a surface of the electrical terminals 220 opposite the crimp teeth 268 is braced against a support, such as a first die. For instance, the mounting plate 231 can extend out from the rear end 212 of the housing body 205 along a direction substantially parallel with the top end 206 of the connector housing 204 (and thus extend in a first plane defined by the lateral direction A and the longitudinal direction L). Alternatively, the mounting plate 231 can extend along a direction angularly offset with respect to the top end 206 (and thus extend in a second plane that is different than the first plane). The flat flex cable 22 can be placed adjacent the crimp teeth 268, for instance adjacent the tapered distal ends 268a, and brought against the crimp teeth 268 such that the crimp teeth 268 pierce the flat flex cable 22 and extend through the flat flex cable 22. A second die can be positioned adjacent the crimp teeth 268, such that the flat flex cable 22 and the mounting portion 224 are disposed between the first and second dies. The first and second dies can then be brought toward each other after the crimp teeth 268 have pierced through the flat flex cable 22, thereby causing the crimp teeth 268 to fold back toward the flat flex cable 22 such that the tapered distal ends 268a are embedded in the flat flex cable 22.

Alternatively, the crimp teeth 268 can pierce through the flat flex cable 22, and the mounting plate 231 can lie against the housing body 205, and the crimp member 267 can be stamped with a die, which is brought against the crimp teeth 268, causing the crimp teeth 268 to fold back along a second direction substantially opposite the first direction such that the tapered distal ends 268a pierce the flat flex cable 22. Thus, the crimp teeth 268 of at least one of the crimp members 267 contacts electrical traces that run therethrough so as to electrically connect the electrical terminals 220 to the flat flex cable 22 as illustrated in FIG. 1. Thus, the crimp teeth 268 can be flexible so as to fold back under the stamping force. The stamping operation can cause the crimp teeth 268 to fold outward or inward as desired. Thus, as the die is brought into contact with the crimp teeth 268, the bottom end 208 of the connector housing 204 provides a mandrel that supports the stamping operation. In order to reduce the crimp forces applied to the connector housing 204 during the stamping operation, the connector housing 204 can be reinforced with a plate or any suitable structure, such as a reinforcement tool that can support the inner surface of the connector housing 204 at the crimp members 267 as desired to provide structural support to the integrity of the connector housing 204 as crimp forces are applied to the crimp teeth 268 and the connector housing 204. The crimp teeth 268 can have any height when uncrimped as desired, it being appreciated that as the height of the crimp teeth 268 increases, the crimp teeth 268 can be crimped against the flat flex cable 22 under reduced stamping forces that are applied against the connector housing 204.

Crimping the crimp teeth 268 against the flat flex cable 22 causes the electrical terminals 220 to place the complementary electrical device that is mated to the mating portions 222 of the electrical terminals 220 in electrical communication with the flat flex cable 22. The flat flex cable 22 can thus define a first end that is mounted onto mounting portions 224 of the terminals, and an opposed second end that is electrically connected to a complementary electrical device, such as a sensor or a processor. Thus, the flat flex cable 22 can place a processor in electrical communication with the mounting portions 224 of the electrical terminals 220 and the mating portions 222 can be electrically connected to a sensor. Conversely, the flat flex cable 22 can place a sensor in electrical communication with the mounting portions 224 of the electrical terminals 220 and the mating portions 222 can be electrically connected to a processor. It should be appreciated that the crimp members 267 can secure a flexible connection to a complementary electrical device, while allowing the electrical connector 202 to have a compact design while providing for ease of manufacturability.

Referring to FIGS. 1A-6D generally, the electrical terminal 220 further includes at least one crimp member 267 at the mounting portion 224, such as a first or inner crimp member 267a and a second or outer crimp member 267b that is outwardly, for instance rearwardly when the electrical terminals 220 are fully installed on the connector housing 204, spaced from the inner crimp member 267a. The crimp teeth 268 of the first crimp member 267a can be disposed about a first perimeter, which can be a perimeter of a first aperture 270, and the crimp teeth 268 of the second crimp member can be disposed about a second perimeter different than the first perimeter. For instance, the second perimeter can be discontinuous with the first perimeter. In accordance with the illustrated embodiment, the second perimeter can be a perimeter of an aperture 270 that is different than the aperture 270 of the first crimp member 267a. Furthermore the first and second perimeters can be substantially circular or alternatively shaped. The electrical terminals 220 can be arranged in one or more pairs 269 of electrical terminals 220. Each pair can include a first electrical terminal 220a of the electrical terminals 220 and a second electrical terminal 220b of the electrical terminals 220 that is adjacent the first terminal. Thus, the electrical connector 202 can define at least one first electrical terminal 220a and at least one second electrical terminal 220b.

The first and second electrical terminals 220a and 220b can be alternatingly arranged along the connector housing 204 in the longitudinal direction L. Thus, first electrical terminals 220a are disposed adjacent, and can be disposed between, the second electrical terminals 220b, and the second electrical terminals 220b are disposed adjacent, and can be disposed between, the first electrical terminals 220a. The first crimp members 267a of each of the first electrical terminals 220a can be aligned along the longitudinal direction L, and the second crimp members 267b of each of the first electrical terminals 220a can be aligned along the longitudinal direction L. Thus, a straight line extending in the longitudinal direction L can substantially pass through the center of the first crimp members 267a of the first electrical terminals 220a, and a straight line extending in the longitudinal direction L can substantially pass through the center of the second crimp members 267b of the first electrical terminals 220a. Likewise, the first crimp members 267a of each of the second electrical terminals 220b are aligned along the longitudinal direction L, and the second crimp members 267b of each of the second electrical terminals 220b are aligned along the longitudinal direction L. Thus, a straight line extending in the longitudinal direction L can substantially pass through the center of the first crimp members 267a of the second electrical terminals 220b, and a straight line extending in the longitudinal direction L can substantially pass through the center of the second crimp members 267b of the second electrical terminals 220b.

In accordance with the illustrated embodiment, the first crimp members 267a of each of the first electrical terminals 220a are offset along the lateral direction A with respect to the first and second crimp members 267a and 267b of each of the second electrical terminals 220b. Thus, the first crimp members 267a of each of the first electrical terminals 220a are not aligned along the longitudinal direction L with the first crimp member 267a of each of the second terminals 220b, and the first crimp members 267a of each of the first electrical terminals 220a are not aligned along the longitudinal direction with the second crimp member 267b of each of the second electrical terminals 220b. Accordingly, a straight line that extends along the longitudinal direction L and passes through the center of the first crimp members 267a of the first electrical terminals 220a does not pass through the center of either or both of the first or the second crimp members 267a and 267b of the second electrical terminals 220b. Likewise, the second crimp members 267b of each of the first electrical terminals 220a are offset with respect to the first and second crimp members 267a and 267b of each of the second electrical terminals 220b along the lateral direction A. Accordingly, a straight line that extends in the longitudinal direction L and passes through the center of the second crimp members 267b of the first electrical terminals 220a does not pass through the center of either or both of the first or the second crimp members 267a and 267b of the second electrical terminals 220b.

Similarly, the first crimp members 267a of each of the second electrical terminals 220b are offset along the lateral direction A with respect to the first and second crimp members 267a and 267b of each of the first electrical terminals 220a. Thus, the first crimp members 267a of each of the second electrical terminals 220b are not aligned along the longitudinal direction L with the first crimp member 267a of each of the first electrical terminals 220a. The first crimp members 267a of each of the second electrical terminals 220b are further not aligned along the longitudinal direction L with the second crimp member 267b of each of the first electrical terminals 220a. Accordingly, a straight line that extends along the longitudinal direction L and passes through the center of the first crimp members 267a of the second electrical terminals 220b does not pass through the center of either or both of the first or the second crimp members 267a and 267b of the first electrical terminals 220a. Likewise, the second crimp members 267b of each of the second electrical terminals 220b are offset with respect to the first and second crimp members 267a and 267b of each of the first electrical terminals 220a along the lateral direction A. Accordingly, a straight line that extends in the longitudinal direction L and passes through the center of the second crimp members 267b of the second electrical terminals 220b does not pass through the center of either or both of the first or the second crimp members 267a and 267b of the first electrical terminals 220a.

The first and second crimp members 267a and 267b of the second electrical terminals 220b can be laterally outwardly disposed with respect to the respective first and second crimp members 267a and 267b of the first electrical terminals 220a, though it should be appreciated that the first and second crimp members 267a and 267b of the first electrical terminals 220a can be laterally outwardly disposed with respect to the first and second crimp members 267a and 267b of the second electrical terminals 220b.

Each crimp member 267 includes a plurality of outwardly extending electrically conductive crimp teeth 268 that are configured to secure the flat flex cable 22 in the manner described above. For instance, one of the first and second crimp members 267a and 267b is configured to electrically connect to electrical traces of the flat flex cable 22, while the other of the first and second crimp members is configured to provide strain relief for the crimp member that is electrically connected to the flat flex cable 22. For instance, the crimp teeth 268 of the second crimp members 267b can engage the flat flex cable 22 such that a majority of a rearwardly directed tensile force applied to the FPC is communicated to the crimp teeth 268 of the second crimp members 267b, while the crimp teeth 268 of the first crimp members 267a that are electrically connected to the flat flex cable 22 are not biased out of electrical connection with the flat flex cable 22 by the applied tensile force. It should be appreciated that when the electrical terminals 220 are electrically connected to the flat flex cable 22, the flat flex cable 22 extends along a rearward direction from the first crimp member 267a toward the second crimp member 267b, and defines a length greater than the distance between the second crimp member 267b and the rear end 212 of the connector housing 204.

It should be appreciated that each of the first and second crimp members 267a and 267b of each of the first and second electrical terminals 220a and 220b can have the same number of crimp teeth 268 or a different number of crimp teeth, as will now be described.

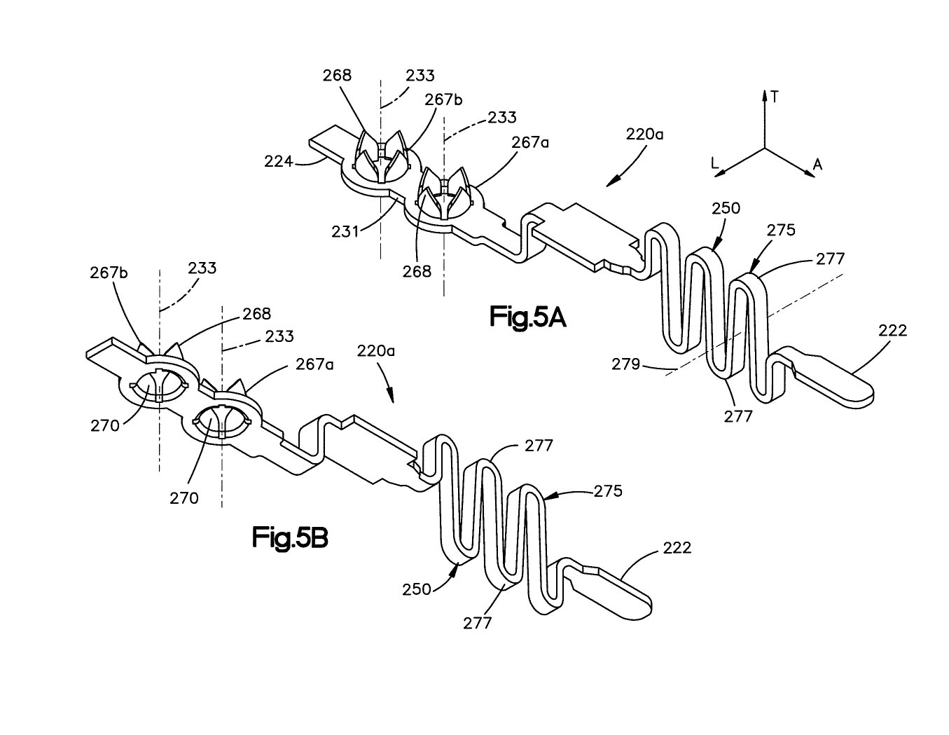

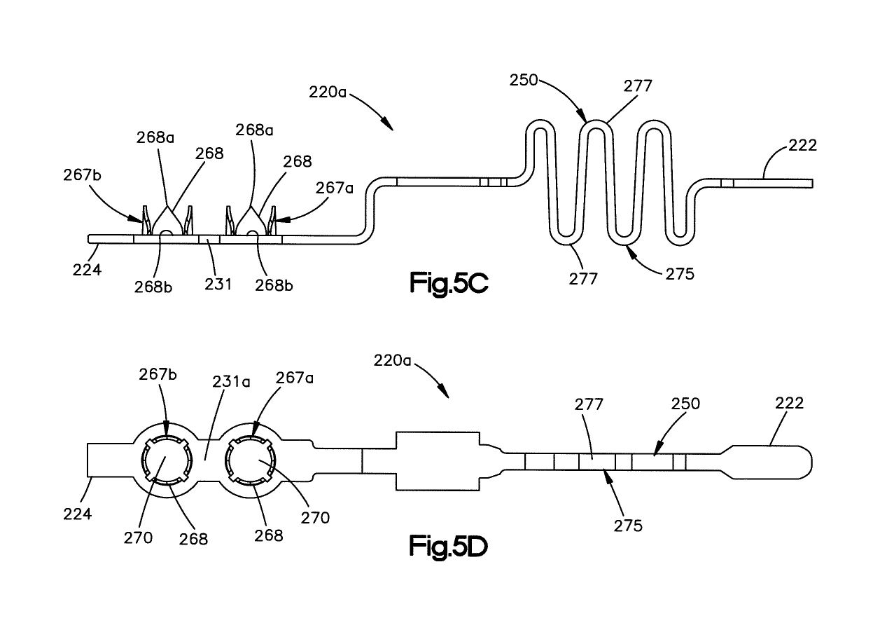

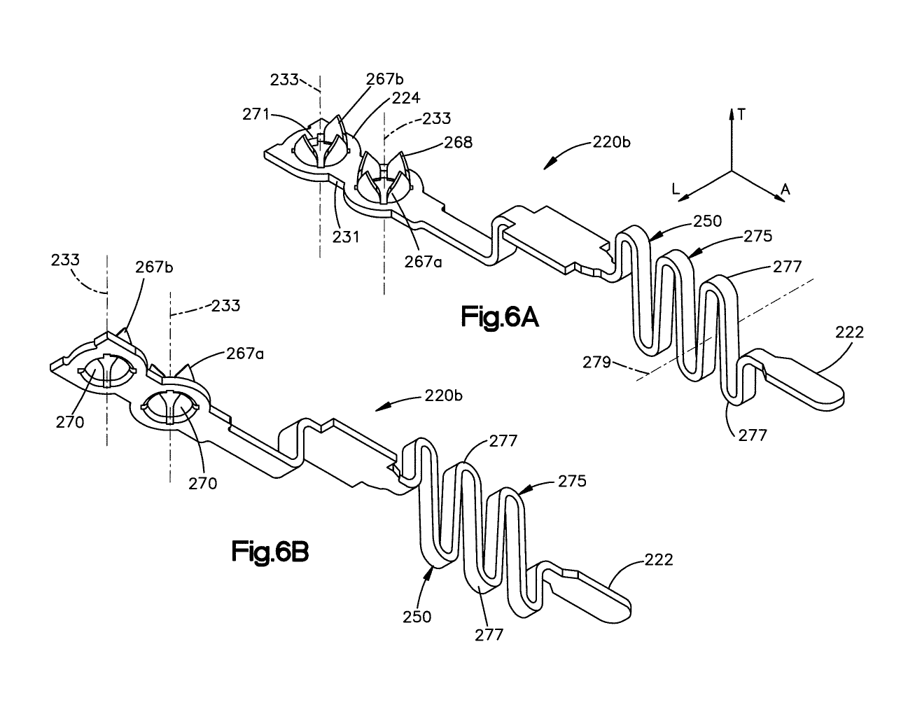

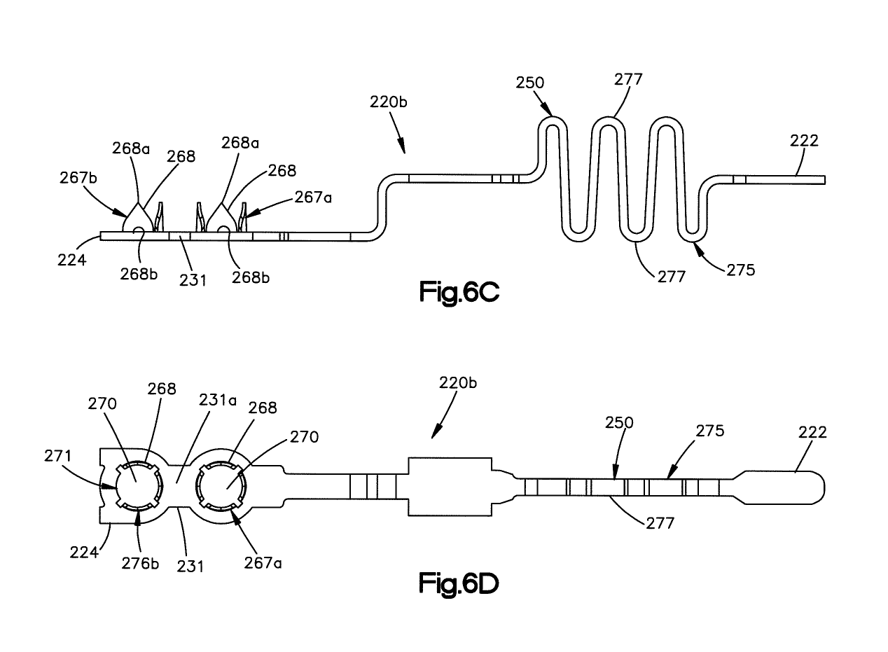

Referring now to FIGS. 5A-6C, it should be appreciated that one of the first and second crimp members 267a and 267b of a select at least one, such as a plurality, up to all, of the first and second electrical terminals 220a and 220b can have a different number of crimp teeth 268 than the other of the first and second crimp members 267a and 267b. For instance, in accordance with the illustrated embodiment, the second crimp members 267b of the second electrical terminals 220b can have a different number, such as fewer or more, crimp teeth 268 with respect to the number of crimp teeth 268 of the first crimp members 267a of the second electrical terminals 220b. Furthermore, one of the first and second crimp members 267a and 267b of the first electrical terminals 220a can have the same number of teeth as the other of the first and second crimp members 267a and 267b of the first electrical terminals 220a. The first and second crimp members 267a and 267b of the first electrical terminals 220a can have the same number of teeth as, or a different number of teeth than, the second crimp member 267b of the second electrical terminals 220b.

In accordance with the illustrated embodiment, the first crimp member 267a of each of the second electrical terminals 220b has four crimp teeth 268, and the second crimp member 267b of each of the second electrical terminals 220b has three crimp teeth 268, and the first and second crimp members 267a and 267b of the first electrical terminals 220a each have four crimp teeth 268, though it should be appreciated that the number of crimp teeth can differ. Accordingly, in accordance with one embodiment, the crimp member 267 that provides strain relief for the electrical interface between the electrical terminals 220 and the flat flex cable 22 can define a fewer number of teeth than the crimp member 267 that is in electrical contact with the electrical traces of the flat flex cable 22. Alternatively, the crimp member 267 that provides strain relief for the electrical interface between the electrical terminals 220 and the flat flex cable 22 can define a greater number of teeth than the crimp member 267 that establishes electrical contact with the electrical traces of the flat flex cable 22. It should be appreciated that both crimp members 267 can establish electrical contact with the electrical traces of the flat flex cable 22, while one of the crimp members also provides strain relief for the other of the crimp members. Furthermore, in accordance with the illustrated embodiment, the crimp teeth 268 of the second crimp member 267b can be configured so as to be variably spaced from each other about the aperture 270. For instance, the crimp teeth 268 of the second crimp member 267b define a pair of crimp teeth 268 that are spaced from each other along the longitudinal direction, and single one of the crimp teeth 268 that is spaced forward along the lateral direction from a gap 271 that is disposed between ones of the pair of crimp teeth 268.

Furthermore, it should be appreciated that the first crimp members 267a of the first electrical terminals 220a can be aligned with the first crimp members 267a of the second electrical terminals 220b along the longitudinal direction L, and the second crimp members 267b of the first electrical terminals 220a can be aligned with the second crimp members 267b of the second electrical terminals 220b along the longitudinal direction L as desired.

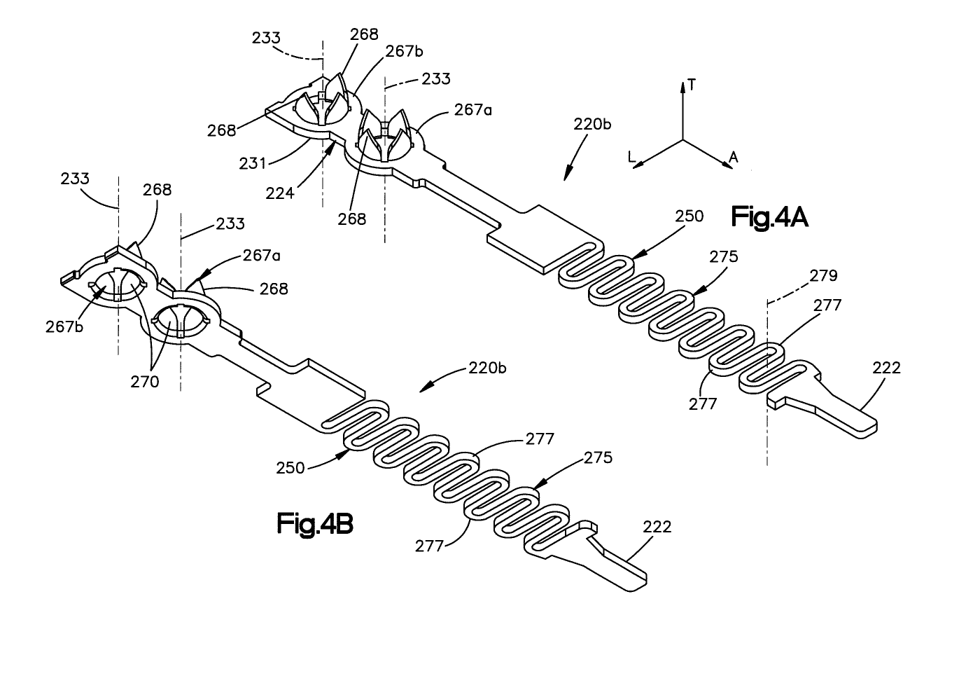

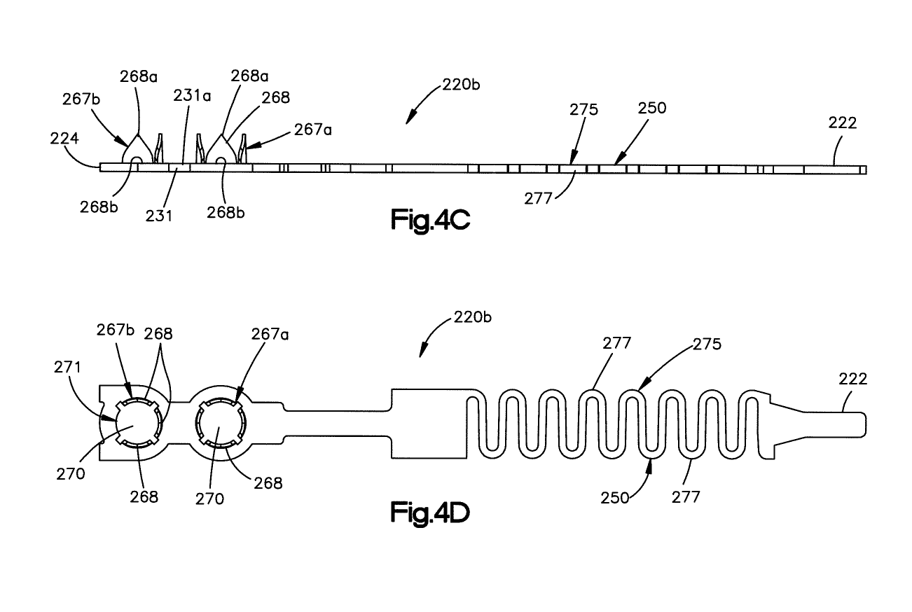

Referring now to FIGS. 3A-4H, at least one or both of the first and second plurality of electrical terminals 220a and 220b can include a laterally compressible spring section 275 that extends between the mating portion 222 and the mounting portion 224. For instance, in accordance with the illustrated embodiment, the intermediate portion of the electrical terminals 220 can define the flexible spring sections 275. The spring section 275 can be defined by a serpentine geometry that defines alternating bent regions 277, which can define substantially U-shaped bends, that extend, and thus can be bent or curved, about respective transverse axes 279 that extend substantially parallel to the transverse axes 233 of the apertures 270 of the crimp members 267. Alternating ones of the bent regions 277 can be inverted with respect to each other along the length of the spring section 275, and can lie in a plane that is defined by the longitudinal and lateral directions L and A, respectively, and thus the plane can extend 1) normal to the transverse axis 233 of the apertures 270 of the crimp members 267, 2) and parallel or coplanar with a plane that is defined by the surface 231a of the mounting plate 231, 3) parallel with at least one or both of the top and bottom ends 206 and 208 of the housing body 205, and 4) parallel with the longitudinal direction L along which the electrical terminals 220, including the mating portions 222, are spaced. At least one up to all of the bent regions 277 can extend in the plane in accordance with the illustrated embodiment.

The spring sections 275 of the electrical terminals 220 can be disposed in the connector housing 204, and in particular can be disposed in respective channels 255 of the housing body 205 (see FIG. 2C). In accordance with the illustrated embodiment, the spring sections 275 are retained between the front end 210 and the rear end 212 of the housing body 205. During operation, a compressive force applied to the mating portions 222 toward the intermediate portion 250, and thus toward the mounting portion 224, for instance by the complementary connector when the electrical connector 202 is mated with the complementary connector, can cause the spring section 275 to compress which moves the mating portion 222 toward the intermediate portion 250, and thus toward the mounting portion 224, and toward the connector housing 204. Upon compression of the spring sections 275, the spring sections 275 provide a contact force against the complementary electrical terminal that is mated to the electrical terminal 220.

Referring now to FIGS. 5A-6H, the laterally compressible spring section 275 can be constructed in accordance with an alternative embodiment. For instance, in accordance with the illustrated embodiment, the intermediate portion of the electrical terminals 220 can define the flexible spring sections 275. The spring section 275 can be defined by a serpentine geometry that defines alternating bent regions, which can define substantially U-shaped bends, that extend, and can thus be bent or curved, about respective longitudinal axes 279 that extend substantially perpendicular to the transverse axes 233 of the apertures 270 of the crimp members 267. Alternating ones of the bent regions 277 can be inverted with respect to each other along the length of the spring section 275, and can lie in a plane that is defined by the transverse and lateral directions T and A, respectively, and thus the plane can extend 1) parallel to the transverse axis 233 of the apertures 270 of the crimp members 267, 2) angularly offset such as orthogonal to the plane that is defined by the surface 231a of the mounting plate 231, 3) angularly offset such as orthogonal with at least one or both of the top and bottom ends 206 and 208 of the housing body 205, and 4) angularly offset such as orthogonal to the longitudinal direction L along which the electrical terminals 220, including the mating portions 222, are spaced. At least one up to all of the bent regions 277 are curved in the plane in accordance with the illustrated embodiment. Furthermore it should be appreciated that the mating portion 222 can be offset with respect to the mounting portion 224 along the transverse direction T.

The spring sections 275 can define a height along the transverse direction T that is less than the height between the opposed top and bottom ends 206 and 208 of the housing body 205 along the transverse direction T. Thus, the spring sections 275 of the electrical terminals 220 can be disposed in the connector housing 204, and in particular can be disposed in respective channels of the housing body 205, such that the spring sections 275 are retained between the front end 210 and the rear end 212 of the housing body 205. During operation, a compressive force applied to the mating portions 222 toward the intermediate portion 250, and thus toward the mounting portion 224, for instance by the complementary connector when the electrical connector 202 is mated with the complementary connector, can cause the spring section 275 to compress which moves the mating portion 222 toward the intermediate portion 250, and thus toward the mounting portion, and toward the connector housing 204. Upon compression of the spring sections 275, the spring sections 275 provide a contact force against the complementary electrical terminal that is mated to the electrical terminal 220.

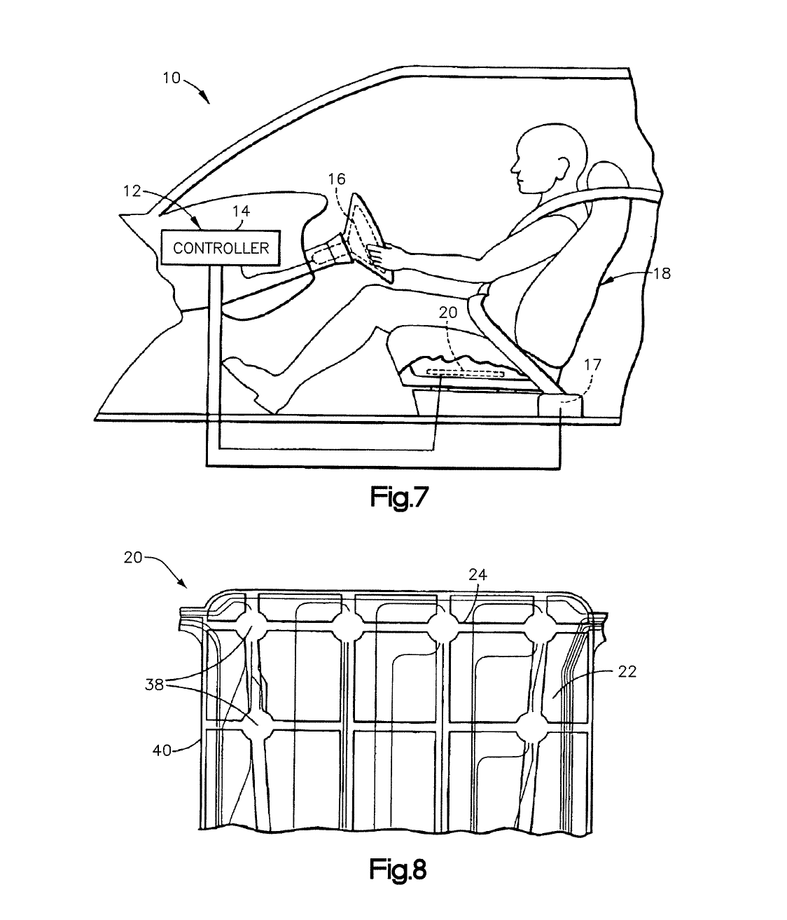

Referring to FIG. 7, there is shown a diagrammatic view of a portion of a vehicle 10 having a safety restraint system 12 incorporating features of the present invention. Although the present invention will be described with reference to the exemplary embodiment shown in the drawings, it should be understood that the present invention can be embodied in many alternate forms of embodiments. In addition, any suitable size, shape or type of elements or materials could be used.

A similar safety restraint system is described in U.S. Pat. Nos. 6,129,168 and 6,932,382, the disclosure of each of which is hereby incorporated by reference in its entirety. The safety restraint system 12 generally comprises a controller 14, airbags 16, 17, and a seat sensor device 20 located in a seat 18. In the embodiment shown, the air bag 16 is a steering wheel mounted air bag. The air bag 17 is a seat belt mounted air bag. The controller 14 can be connected to other air bags in the vehicle 10, such as a passenger side dashboard mounted air bag and side mounted air bags, for example. The controller 14 is connected to the air bags 16, 17 to control their deployment. The controller 14 is also connected to various sensors located about the vehicle as is generally known in the art.

One of the sensors connected to the controller 14 is the seat sensor device 20 located in the seat 18. In the embodiment shown, the seat sensor device 20 is shown in the driver's seat. One or more additional seat sensor devices could be located in one or more of the passenger seats. The seat sensor device 20 is adapted to determine the size and position of a person sitting in the seat. The information sensed by the seat sensor device 20 is transmitted back to the controller 14 to allow the controller to determine if and/or at what force the air bags 16, 17 should be deployed in the event of an accident.

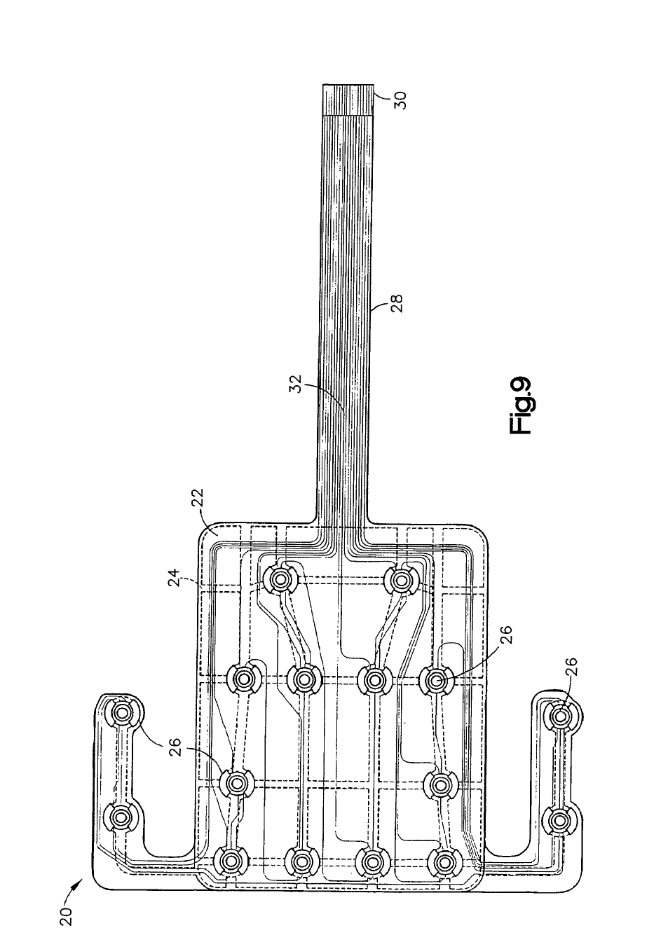

Referring now also to FIGS. 8-10, the seat sensor device 20 generally comprises a flexible printed circuit (FPC) 22, a frame 24, and a plurality of Hall effect sensor assemblies 26. The controller 14 can include the electrical connector 202 mounted to the FPC as described above, and a complementary electrical device mated to the electrical connector 202 and having a processor that receives signals from the various sensors to determine if and/or at what force the air bags 16, 17 should be deployed. As seen best in FIG. 8, the flexible printed circuit 22 is provided in the general shape of a mat. The FPC mat 22 has a connection tail 28 with contact sections 30. Electrical conductors 32 extend through the FPC mat 22 and are covered by electrical insulation. The frame 24 is generally comprised of molded plastic. The frame 24 provides a support for the FPC mat 22. The frame 24 is located against a bottom side of the FPC mat 22. As shown in FIG. 11, the frame 24 comprises pairs of snap lock latches 34 which extend through holes in the FPC mat 22 such that the snap lock latches are located on the top side of the FPC mat. Each of the opposing pairs of snap lock latches 34 form a receiving area 36 therebetween on the top side of the FPC mat 22. As shown best in FIG. 9, the frame 24 comprises support sections 38 connected to each other by a support lattice section 40. The support sections 38 comprise a general flat disk shape. The snap lock latches 34 extend from a top side of the support sections 38. Thus, the support sections 38 provide a substantially flat surface 42 on the top side of the frame 24 between each of the pairs of snap lock latches 34.

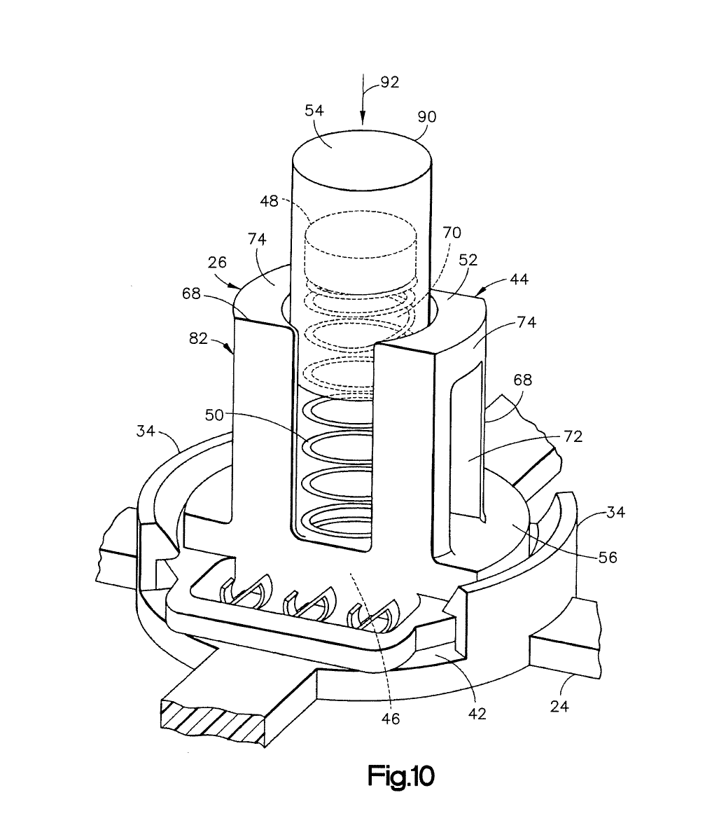

Referring now particularly to FIG. 10, a portion of the frame 24 is shown with one of the Hall effect sensor assemblies 26 attached thereto. FIG. 10 shows the seat sensor device without showing the FPC mat 22 merely for the sake of clarity. The FPC mat 22 would be located between the flat surface 42 and the bottom side of the Hall effect sensor assembly 26. The FPC mat is essentially sandwiched between the bottom side of the sensor assembly 26 and the flat surface 42. The Hall effect sensor assembly 26 generally comprises a housing 44, a Hall effect sensor 46, a magnet 48, and a spring 50. In the embodiment shown, the seat sensor device 20 comprises sixteen of the Hall effect sensor assemblies 26 (see FIG. 8). However, in alternate embodiments, the seat sensor device could comprise more or less than sixteen Hall effect sensor assemblies. In addition, the Hall effect sensor assemblies could be positioned in any suitable type of array on the FPC mat 22.

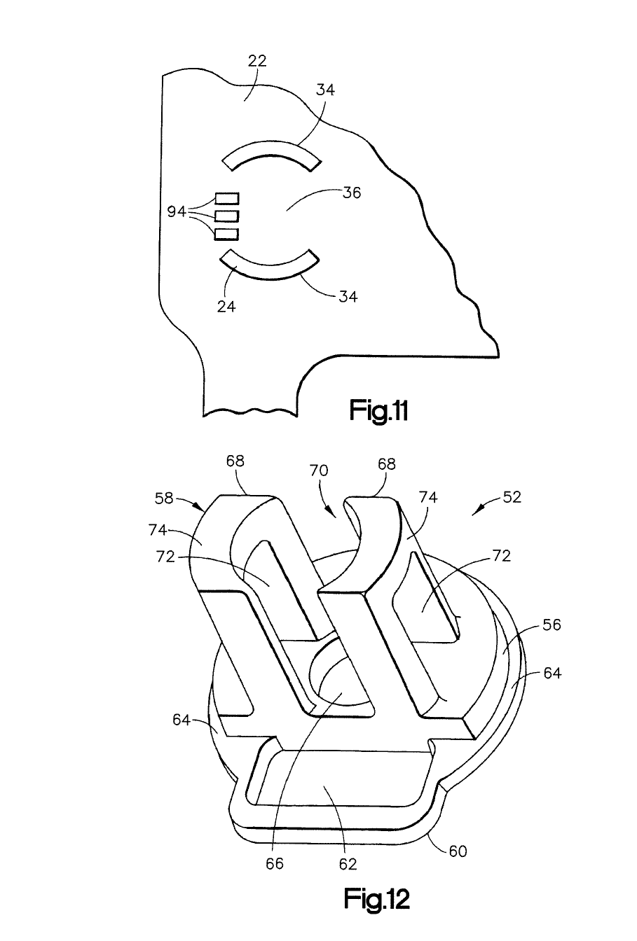

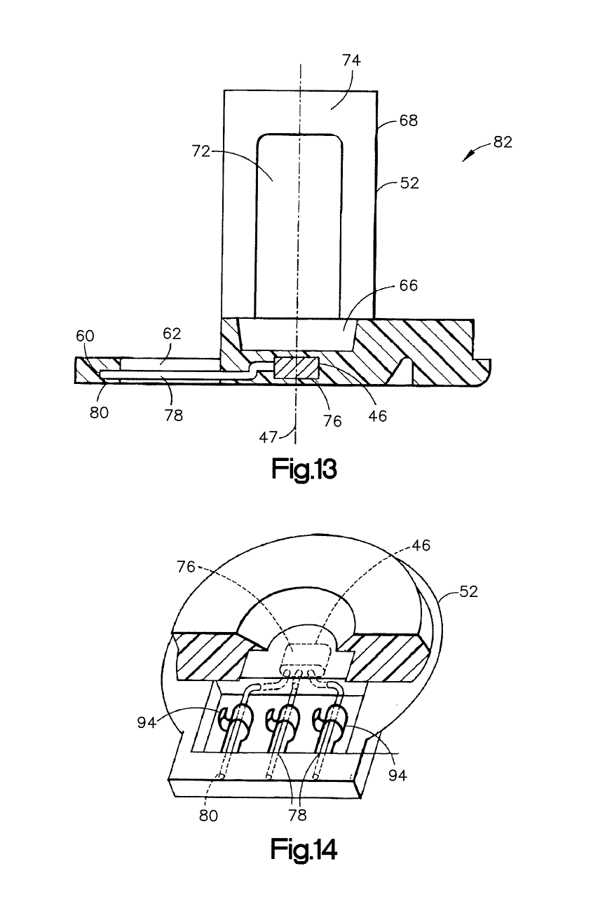

Referring also to FIGS. 12-16, the housing 44 generally comprises a first housing member 52 and a second housing member 54. The first housing member 52 is preferably comprised of molded plastic or polymer material. As seen best in FIGS. 12 and 13, the first housing member 52 generally comprises a base section 56 and a general tube section 58. The base section 56 generally comprises an extension 60 having an open aperture 62, snap lock ledges 64, and a central spring cavity 66. The general tube section 58 extends in an upward direction from the top side of the base section 56 around the spring cavity 66. The general tube section 58 generally comprises two opposing curved columns 68. The two columns 68 defined a magnet movement path therebetween. More specifically, the two columns 68 define an area 70 which is adapted to receive the second housing member 54 which houses the magnet as further described below. In the embodiment shown, each of the columns 68 include an alignment slot 72 therein. The alignment slots 72 are used to movably attach the second housing member 54 to the first housing member 52 as further described below. The top sides of the alignment slots 72 are closed by transverse sections 74 of the columns.

Referring particularly to FIGS. 13 and 14, the Hall effect sensor 46 is housed, at least partially, inside the first housing member 52. Thus, the first housing member 52 and the Hall effect sensor 46 form a first subassembly 82. In a preferred embodiment of the present invention, the first housing member 52 comprises an overmolded housing which is overmolded over portions of the Hall effect sensor 46. The Hall effect sensor 46 generally comprises a sensing section 76 and three electrical leads 78. One lead is for power, one lead is for ground and one lead is for signals. In a preferred embodiment, the Hall effect sensor 46 is a range taking sensor capable of continuous signaling of distance of the magnet relative to the sensor 46. However, in alternate embodiments, the Hall effect sensor could be adapted to signal two or more range settings, such as by using a step capable sensor.

The three electrical leads 78 span across the open aperture 62 of the extension 60 in the first housing member 52 and, more specifically, the electrical leads 78 comprises exposed middle sections which do not have the overmolded housing member 52 thereon. The electrical leads 78 comprises distal ends 80 which are fixedly attached to the first housing member 52 by the overmolding process. The proximal end of the electrical leads 78 are also fixedly attached to the first housing member by the overmolding process. Thus, the first housing member 52 retains the exposed middle sections of the electrical leads in a fixed, spaced orientation relative to each other and a fixed orientation relative to the overmolded housing member 52.

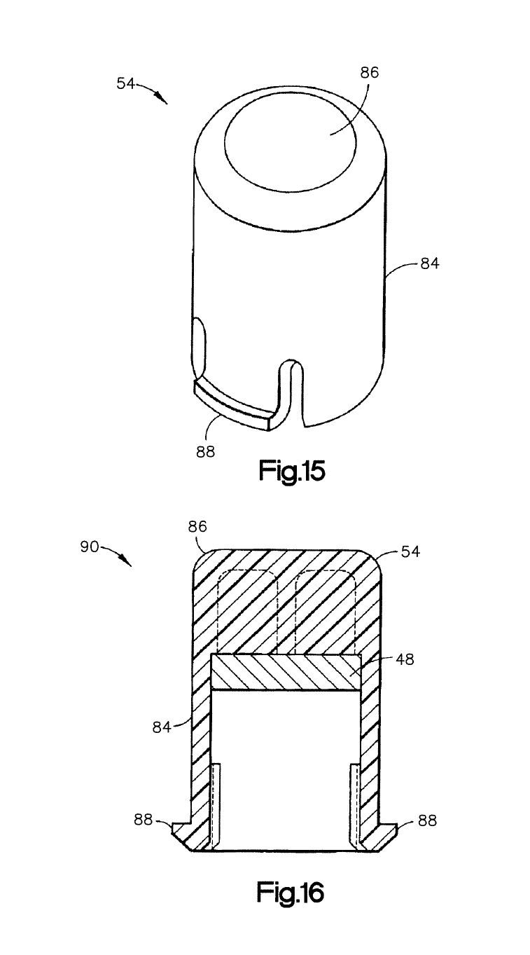

Referring particularly to FIGS. 15 and 16, the second housing member 54 generally comprises a one-piece member preferably comprised of molded plastic or polymer material. The second housing member 54 generally comprises a tube shaped section 84, a top section 86 and snap lock latches 88 forming a bottom part of the tube shaped section 84. The magnet 48 is located inside the tube shaped section 84 against the bottom side of the top section 86. The magnet 48 is preferably press fit inserted into the second housing member. Thus, the second housing member 54 and magnet 48 form a second subassembly 90.

As seen in FIG. 10, the spring 50 is connected between the two subassemblies 82, 90. A first end of the spring 50 is located in the spring cavity 66 of the first housing member 52 (see FIG. 12) and a second opposite end of the spring is located inside the tube shaped section 84 of the second housing member 54. The second opposite end of the spring 50 is located directly against the bottom side of the magnet 48. The spring 50 biases the second subassembly 90 in an upward direction as shown in FIG. 10. In a preferred embodiment the spring is comprised of nonferrous material such that it does not impact the magnetic field.

In order to assemble the two subassemblies 82, 90 and spring 50 together, the spring is placed in the spring cavity 66 and the second subassembly 90 is inserted into the top of the first subassembly 82 as indicated by arrow 92 with the bottom of the second housing 54 entering into the area 70 between the two columns 68. The area 70 is sized and shaped to slidably received the second housing member 54 therein. As the second housing member 54 is inserted into the area 70, the snap lock latches 88 are resiliently deflected in an inward direction until the latches pass by the transverse sections 74 of the columns 68. The snap lock latches 88 are then able to deflect outward and into the two alignment slots 72. This provides a snap lock connection of the second housing member 54 to the first housing member 52.

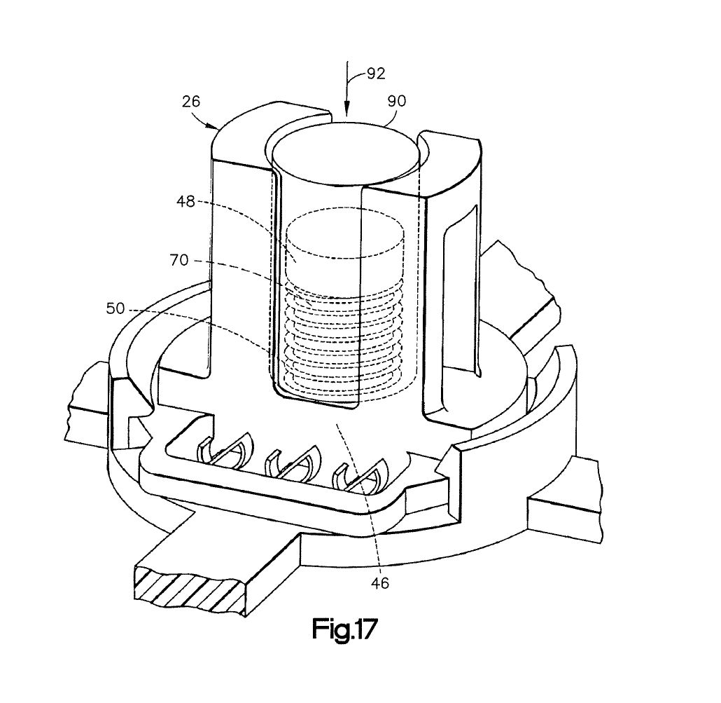

The snap lock connection merely prevents the second subassembly 90 from becoming disengaged from the first subassembly 82. However, the connection of the two subassemblies 82, 90 to each other provides a movable connection. More specifically, the outer portions of the snap lock latches 88 are adapted to vertically slide in the alignment slots 72. Referring also to FIG. 17, the Hall effect sensor assembly 26 is shown similar to that shown in FIG. 10, but in this configuration the second subassembly 90 has been depressed as indicated by arrow 92 in an inward direction; further into the area 70. This results in the spring 50 being resiliently compressed and the magnet 48 being moved closer to the Hall effect sensor 46. When force is reduced on the top surface of the second subassembly 90, the spring 50 can move the second subassembly and the magnet 48 in a direction away from the Hall effect sensor 46. With the present invention, the movably connection between the two housing members 52, 54 provides a telescoping type of movement which allows the magnet to move towards and away from the Hall effect sensor 46 along a Hall effect central sensing axis 47 (see FIG. 13). The movable connection is designed to prevent the magnet 48 from getting out of parallel with the Hall effect sensor 46 by more than ten degrees. In a preferred embodiment, the magnet might only be able to tilt or move out of alignment by 5-10 degrees.

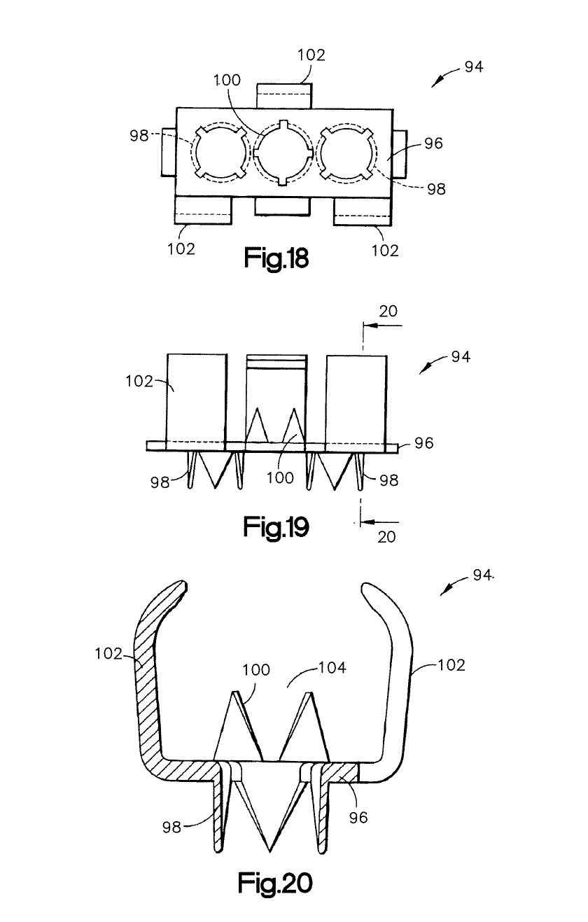

As seen best in FIGS. 11 and 14F, the seat sensor device 20 includes electrical terminals 94. More specifically, in the embodiment shown, three of the terminals 94 are provided at each of the sensor assemblies 26; one terminal for each one of the electrical leads 78 of the Hall effect sensor 46. Referring also to FIGS. 18-20, one of the terminals 94 is shown. Each terminal 94 generally comprises a one-piece electrically conductive member. In a preferred embodiment, the terminal 94 is comprised of flat sheet metal which has been stamped into the shape shown. The terminal 94 generally comprises a center section 96, bottom extending sections 98, a top extending section 100, and upward extending side sections 102.

The terminals 94 are fixedly attached to the FPC mat 22 before the sensor assemblies 26 are connected. More specifically, the terminals 94 are pressed against the top surface of the FPC mat 22 with the bottom extending sections 98 piercing through the mat and being deformed outward and upward to form a mechanical and electrical connection with individual ones of the electrical conductors 32 in the mat. When the sensor assemblies 26 are being connected to the FPC mat 22 and the snap lock latches 34 of the frame 24, the terminals 94 are received in the open aperture 62 of the extension 60 through the bottom of the first housing member 52. The electrical leads 78 of the Hall effect sensors 46 are each positioned into the area 104 between the side sections 102 of one of the terminals.

The side sections 102 are then deformed inward towards the area 104 to clamp the middle exposed sections of the electrical leads 78 into a mechanical and electrical connection with the top extending section 100 and side sections 102 against the top side of the center section 96. If the electrical leads 78 comprise electrical insulation, the relatively sharp edges on the top extending section 100 is adapted to cut through the electrical insulation to insurer electrical contact between the terminal 94 and the electrical conductor of the electrical lead 78. However, in alternate embodiments, any suitable type of terminal or method of electrically connecting the electrical leads 78 to the electrical conductors 32 of the FPC mat 22 could be provided. However, in the embodiment shown, the terminals 94 are adapted to allow the side sections 102 to be moved to an open position again to allow the sensor assembly 26 to be removed from connection with the terminals. A replacement sensor assembly can be connected to the FPC mat to replace a broken or faulty original sensor assembly 26. Thus, in a preferred embodiment, the electrical connection of the sensor assembly 26 to the conductors in the FPC mat is preferably a removable connection. In an alternate embodiment, the electrical connection might not comprise a removable connection.

Referring back to FIG. 10, the sensor assembly 26 is attached to the frame 24 by inserting the base section 56 through the top side of an opposing pair of the snap lock latches 34. The snap lock ledges 64 (see FIG. 12) of the first housing member 52 snap beneath portions of the snap lock latches 34. The present invention, unlike conventional designs, does not need a separate lock to attach the frame to the FPC mat. With the present invention, the first housing member 52 functions as the lock to attach the FPC mat to the frame 24. The use of the first housing member 52 as the lock allows the seat sensor device 20 to be manufactured with less components. The assembly of the seat sensor device 20 comprises less steps and is therefore quicker to assemble.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated. Accordingly, those skilled in the art will realize that the invention is intended to encompass all modifications and alternative arrangements included within the spirit and scope of the invention, for instance as set forth by the appended claims.

What is claimed:

1. An electrical connector comprising:
a connector housing;
at least one electrical terminal supported by the housing, the electrical terminal defining a mating portion and a mounting portion, the mounting portion carrying at least one crimp member that has crimp teeth configured to pierce through a flex cable when crimped so as to mount the flex cable to the mounting portion of the electrical terminal, and a spring section that extends between the mating end and the mounting end, the spring section configured to compress such that the mating end moves toward the mounting end.

2. The electrical connector as recited in claim 1, wherein the spring section defines a plurality of alternating bent regions that each extend about an axis.

3. The electrical connector as recited in claim 2, wherein the crimp members define an aperture that extends along a central axis, wherein the central axis of the aperture is substantially parallel with the axis of the bent regions.

4. The electrical connector as recited in claim 2, wherein the crimp members define an aperture that extends along a central axis, wherein the central axis of the aperture is substantially perpendicular with respect to the axis of the bent regions.

5. The electrical connector as recited in claim 2, wherein the crimp member extends from a surface, and the bent regions extend along a plane that is substantially parallel to a plane defined by the surface.

6. The electrical connector as recited in claim 5, wherein the plane defined by the surface is coplanar with the plane of the bent regions.

7. The electrical connector as recited in claim 2, wherein the crimp member extends from a surface, and the bent regions extend along a plane that is substantially orthogonal to a plane defined by the surface.

8. The electrical connector as recited in claim 1, wherein the spring section has a serpentine geometry.

9. The electrical connector as recited in claim 1, further comprising a pair of spaced crimp members that each have crimp teeth configured to pierce through a flex cable when crimped so as to mount the flex cable to the mounting portion of the electrical terminal.

10. The electrical connector as recited in claim 9, wherein each of the pair of crimp members has the same number of crimp teeth.

11. The electrical connector as recited in claim 9, wherein the pair of crimp members have different numbers of crimp teeth.

12. The electrical connector as recited in claim 1, wherein the connector housing comprises a housing body and a pair of latch arms that extend from a front end of the housing body.

13. The electrical connector as recited in claim 12, wherein the spring sections are retained between the front end of the housing body and an opposed rear end of the housing body.

14. The electrical connector as recited in claim 12, further comprising a latch lever pivotally attached to the latch arms so as to be movable between an extended position and a retracted position.

15. The electrical connector as recited in claim 14, further comprising at least one grip member that extends from one of the latch arms and is configured to interfere with the latch member so as to releasably secure the latch arm in the retracted position.
